(19) United States
(12) Patent Application Publication
(10) Pub. No.: US 2011/0071249 A1
(43) Pub. Date: Mar. 24, 2011

(54) Fast-Drying Ink Composition

(76) Inventors: Loc Bui, Moorpark, CA (US); Ramesh Subbaraman, Fullerton, CA (US); Snehal Desai, Irvine, CA (US); Barry Brucker, Beverly Hills, CA (US); Nadeepuram K. Ranganathan, Irvine, CA (US)

(21) Appl. No.: 12/634,998

(22) Filed: Dec. 10, 2009

Related U.S. Application Data
(60) Provisional application No. 61/121,430, filed on Dec. 10, 2008.

(51) Int. Cl. C08L 37/00; C08L 33/02; C09D 11/00; C08L 29/04; C08L 39/06; C08L 67/00; C08L 61/06

(52) U.S. Cl. 524/549; 524/556; 106/31.13; 524/543; 524/548; 524/599; 524/592; 524/611; 524/596

(57) ABSTRACT

A fast-drying ink composition comprising water, a fast-drying solvent mixture including a hydrophilic co-solvent having low enthalpy of evaporation, a surface-active humectant, and a colorant. The hydrophilic co-solvent may be selected from the group consisting of propylene glycol n-propyl ether, tripropylene glycol methyl ether, and dipropylene glycol methyl ether. The surface-active humectant may comprise a hydrophobic end having a repeating unit “n” ranging from 1 to 36 and selected from the group consisting of alkane-based (CH₂)n, fluoro-based (CF₂)n, and silicone-based (SiO)n, and a hygroscopic end having a repeating unit “i” ranging from 2 to 8 and selected from the group consisting of a hydroxyl group, an amine group, a carboxyl group and an ester group.

### RELATED APPLICATIONS

This application claims priority and is entitled to the filing date of U.S. Provisional application Ser. No. 61/121,430 filed Dec. 10, 2008, and entitled “Fast-Drying Ink Composition.” The contents of the aforementioned application are incorporated by reference herein.

### BACKGROUND OF THE INVENTION

### Incorporation by Reference

Applicant(s) hereby incorporate herein by reference any and all U.S. patents and U.S. patent applications cited or referred to in this application.

1. Field of the Invention

Aspects of this invention relate generally to inks, and more particularly to fast-drying ink compositions and methods of their use in printing systems.

2. Description of Related Art

In the industrial printing market, there exists a need for a low cost, high performance printing system that enables imaging of data onto a variety of porous and/or non-porous substrates. The technologies most often employed in the industrial printing market are continuous inkjet and drop-on-demand inkjet.

With regard to continuous inkjet systems, solvent based inks are typically the inks of choice to print on the various substrates required. The ink composition is typically based on solvents, e.g., methyl ethyl ketone (“MEK”) and/or alcohol, and one or more solvent-soluble colorants. Inks for continuous inkjet systems are generally conductive since an electrostatic charging device is employed to assist in directing the continuous stream of ink droplets. In such continuous inkjet systems, the ink droplets to be imaged are jetted from a nozzle as a continuous stream and directed to a substrate. The un-imaged or unused ink droplets are recycled back into the bulk ink feed system. Due to the high volatility nature of solvent-based inks and the recycling of the un-imaged ink droplets, a make-up solution comprising an effective concentration of the solvent(s) is typically employed to compensate for the loss in solvent(s) during printing.

Due to the high volatility of continuous inkjet inks, a plurality of problems are often encountered with continuous inkjet technology. Volatile inks tend to generate volatile organic compounds (“VOCs”) that are not environmentally friendly upon the loss of the solvent(s). Loss of the solvent(s) from such volatile inks also tends to cause the ink to increase in viscosity. To compensate for the loss of solvents(s) and the resulting increase in viscosity, again, make-up solution is added. The addition of make-up solution increases the cost of operation. Furthermore, the variability in the physical properties of the ink due to the loss of solvent(s) and the compensation by the make-up solution creates variability in quality of the printed image. As a result of these factors, and due to the relative complexity of the technology more generally, continuous inkjet systems ultimately tend to be expensive to own and maintain.

To overcome the volatility problems related to solvent inks employed in continuous inkjet system, and in the alternative, hot melt ink may be employed using a drop-on-demand printing system. In such hot melt ink printing systems, the ink composition is typically based on low molecular weight waxes and oil soluble colorant(s). The ink is typically a solid at room temperature. During the imaging process, the ink is heated up above the melting point to an effective temperature where the ink is jettable. The molten ink is jetted from the nozzles of the print head and onto the desired substrate via a micro piezo-actuated device. The molten ink droplets freeze on top of the substrate to form the desired image. Since this is a solid ink system, there is no solvent being lost to evaporation. However, the printed images tend to suffer from a lack of image durability. The solid printed image sitting on top of the substrate tends to mar and scuff relatively easily when it comes into contact with various feeding rollers in the industrial printing environment, often rendering the image even illegible. Furthermore, the typical hot melt inkjet printing system does nothing to remedy the high system and maintenance cost problems that result primarily from the expensive low volume print head design and manufacturing and from the high power requirement to heat the system and print head(s).

Thus, although solid ink drop-on-demand technology resolves the volatility problem of continuous inkjet technology by not using solvents, the cost issues have not been resolved. In addition, hot melt ink technology tends to suffer from a durability problem of the printed image.

Recently, new drop-on-demand printing systems based on thermal inkjet technology available from such companies as Hewlett Packard® have been integrated for the industrial printing market. Such thermal inkjet technology is based on the disposable, inexpensive print head technology that has been commercially successful in the high volume office printing market for many years. Integrators of the thermal inkjet technology have been able to simultaneously address both issues of high system cost and maintenance cost.

In thermal ink jet technology, the ink composition is typically based on water and glycols. The colorants typically are water soluble dyes or water dispersible pigments. Because of the inherent water solubility of water-soluble dyes, the images printed from these inks suffer from a lack of waterfastness. Whereas, water-based inks employed in thermal inkjet systems have found great commercial success in printing on porous or absorbent substrates. However, water based inks are notorious for requiring appropriate substrates to be selected for optimum print quality and when printed on non-porous substrates often suffer from low edge acuity, poor wetting, inadequate drying, coalescence in the halftone image, mottling, smudging, low optical density, poor adhesion to the substrate, lack of waterfastness, and other such problems. Furthermore, thermal inkjet technology is prone to long-term reliability issues such as nozzles clogging from dried ink at the orifices, kogation due to thermal degradation at the resistors, or corrosion due to oxidative problems.

Thus, water-based inks traditionally employed in thermal printheads may be inappropriate for printing on non-porous substrates. The inks may not wet the substrate.

Even if the inks are modified to wet the non-porous substrate, water-based inks may take too long to dry on non-porous substrates. To resolve the drying problem on non-porous substrates, inks with fast-drying solvent and/or fast-drying solvent mixture may be employed. However, inks with fast-drying solvent and/or fast-drying solvent mixture may often result in reduced open time at the nozzle during printing and/or during idling. Further, the rapid evaporation of the fast-drying solvent and/or fast-drying solvent mixture from the inks upon idling may often lead to irrecoverable clogging of the nozzles and/or clogging of the nozzles that would require user intervention.

As the term is employed herein, open time is the time the print head is in the idling state, i.e., non-printing, uncapped state, without losing any jet. For example, an open time of one hour means the print head has been in a non-printing, uncapped state for one hour and is able to print with one-hundred percent of all the jets.

As the term is employed herein, there are several states of clogging of the nozzles. Irrecoverable nozzle clogging refers to the solvent evaporating from the ink, and the nozzles are irrecoverable despite user intervention.

In recoverable nozzle clogging, there are two different states, where one state requires user intervention and the other state does not require user intervention. For example, recoverable nozzle clogging requiring user intervention means the nozzles may be recovered by removing the printhead to wipe the nozzle plate and/or flushing the printhead. Whereas, recoverable nozzle clogging without user intervention means the jets may be recovered by programming the printhead to fire the jets and/or purging the printhead.

In sum, there are several disadvantages to the aforementioned methods. Continuous inkjet systems may be expensive to own and maintain. Additionally, continuous inkjet inks might be highly volatile, might create print quality problems, might generate VOCs into the environment, and might add cost to the operation. Hot melt drop-on-demand inkjet systems may be able to resolve the issues related to volatility found in continuous inkjet systems. However, hot melt inkjet systems generally introduce printed images of low durability without resolving the cost issues. Thermal inkjet systems may be able to resolve the cost and ink volatility issues. However, thermal inkjet systems introduce problems with printing on non-porous substrates. Thus, the prior art described above teaches inks and ink systems that may be relatively inexpensive to operate, relatively non-volatile, or relatively successful in printing quality images on non-porous substrates, but does not teach inks and ink systems that are capable of achieving all of these objectives.

Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the above-described problems by providing, in the exemplary embodiment, a fast-drying ink composition for use in printing on various substrates, including non-porous substrates.

Generally, the inventors herein realize, in one aspect of the invention, that there is a need for a versatile ink to enable printing using thermal inkjet technology or the like on a variety of porous and non-porous substrates required in industrial printing applications. Such substrates include but are not limited to coated offset paper, low surface energy plastic, glass, or metal. In another aspect of the invention, the inventors herein realize that by employing fast-drying solvent and/or a mixture thereof in an ink to be jettable in a thermal inkjet system may result in a fast-drying ink composition on porous or non-porous substrates. In yet another aspect of the invention, the inventors herein realize that incorporating a surface active humectant into a fast-drying ink to be jettable in a thermal inkjet system may result in a fast-drying ink composition with good recovery after coming out of standby.

A primary objective inherent in the above described apparatus and method of use is to provide advantages not taught by the prior art.

Another objective is to provide such an ink composition that comprises water, a fast-drying solvent mixture, a surface active humectant, and a colorant.

A further objective is to provide such an ink composition that comprises a hydrophilic co-solvent with low enthalpy of evaporation.

A still further objective is to provide such an ink composition that comprises a humectant.

A still further objective is to provide such an ink composition that comprises a surfactant selected from the group consisting of hydrocarbon-based surfactants, silicone-based surfactants, or fluorosurfactants.

A still further objective is to provide such an ink composition that comprises at least two surfactants mixed in the ink either as a fluorosurfactant with a hydrocarbon-based surfactant or as a silicone-based surfactant with a hydrocarbon-based surfactant.

A still further objective is to provide such an ink composition that comprises a resin.

A still further objective is to provide such an ink composition that comprises a biocide reagent.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a schematic view of the chemical structure of a surface-active humectant of an exemplary embodiment of the invention; and

FIG. 2 is a schematic view the surface-active humectants at an air-water interface.

### DETAILED DESCRIPTION OF THE INVENTION

The above described drawing figures illustrate aspects of the invention in at least one of its exemplary embodiments, which are further defined in detail in the following description.

Described now in detail is a fast-drying ink composition comprising, in the exemplary embodiment, water, one or more fast-drying solvents, a surface-active humectant, and at least one colorant. These ingredients and other additives such as “low enthalpy of evaporation” solvents, surfactants, resins, and biocide reagents may be combined in various proportions depending on the application to arrive at new and useful ink compositions according to the present invention.

As employed herein, an “effective amount” or “effective concentration” of any such ingredient or additive of any particular ink composition refers to the minimal percentage of a substance employed in an ink composition of the present invention to achieve the desired effect. For example, an effective amount of dye refers to the minimal percentage of dye required to achieve the desired color and/or optical density.

While specific substances in each broad category of ingredients are described as being combined in certain proportions to yield one or more particular ink compositions, it will be appreciated by those skilled in the art that the invention is not so limited. Rather, numerous other substances, now known or later developed, and combinations thereof are possible beyond those described herein without departing from the spirit and scope of the invention.

### Fast-Drying Solvents

Fast-drying solvents suitable for the ink compositions of the present invention may comprise a single solvent and/or a mixture of solvents, most of which are organic, though this is not required.

In accordance with one embodiment of the present invention, alcohols may typically be employed as the fast-drying solvent in various ink compositions of the present invention to modify the drying property of the resulting ink. Alcohols suitable for the ink compositions of the present invention may include, but are not limited to, methanol, ethanol, isopropyl alcohol, n-propyl alcohol, tert-butanol, n-pentanol, benzyl alcohol, and derivatives thereof.

For example, methanol may be added to an ink composition of the present invention to increase the drying rate. To slow down the drying rate of an ink composition, benzyl alcohol may be added. An effective concentration of alcohol may be empirically determined relative to the desired end use application to balance between the problem of crusting at the nozzles and achieving the desired drying rate.

In one embodiment, an alcohol and/or a mixture of alcohols may typically be present in the range of about one percent (1%) to about seventy-five percent (75%) by weight, more preferably in the range of about five percent (5%) to about fifty percent (50%) by weight, and even more preferably in the range of about eight percent (8%) to about forty percent (40%) by weight. In another embodiment, the alcohol may be added individually and/or as a mixture of different alcohols in an effective concentration to achieve desired end properties.

In yet another embodiment, glycol ethers and or esters may be employed as the fast-drying solvent in various ink compositions of the present invention to modify the drying property of the resulting ink.

Suitable glycol ethers employed in various ink compositions of the present invention may include, but are not limited to, propylene glycol methyl ether (“glycol ether PM” or “GEPM”), dipropylene glycol methyl ether, tripropylene glycol methyl ether, propylene glycol ethyl ether, propylene glycol normal propyl ether, dipropylene glycol normal propyl ether, dipropylene glycol normal butyl ether, dipropylene glycol normal butyl ether, tripropylene glycol normal butyl ether, dipropylene glycol tertiary butyl ether, diethylene glycol methyl ether, diethylene glycol ethyl ether, diethylene glycol butyl ether, and derivatives thereof.

In one embodiment, esters suitably employed in the ink compositions of the present invention may include, but are not limited to, amyl acetate, iso-butyl acetate, n-butyl acetate, glycol ether DB acetate, glycol ether EB acetate, glycol ether DE acetate, glycol ether EE acetate, glycol ether EM acetate, glycol ether PM acetate, ethyl acetate, ethyl-3-ethoxy propinate, isopropyl acetate, n-propyl acetate, isobutyl isobutyrate, dibasic ester, and derivatives thereof.

In another embodiment, glycol ethers and esters might be employed as co-solvents to balance various properties of a particular ink composition of the present invention. In an exemplary embodiment, a relatively fast-evaporating solvent such as ethyl acetate may be employed to increase the drying rate of an ink composition. Alternatively or concurrently, a relatively slow-evaporating solvent such as glycol ether PM acetate may be employed to decrease the drying rate of an ink composition. In an alternative exemplary embodiment, glycol ethers and esters may be added to an ink composition in various combinations and effective percentages by weight to achieve the desired balance in properties.

In one embodiment, oxygenated solvents suitably employed in the ink compositions of the present invention may include, but are not limited to, glycol ethers such as propylene glycol n-propyl ether (“Glycol Ether PnP”), tripropylene glycol methyl ether (“Glycol Ether TPM”) and/or dipropylene glycol methyl ether (“Glycol Ether DPM”).

In a further embodiment, Glycol Ether PnP, Glycol Ether TPM and Glycol Ether DPM may be employed in the ink compositions to offer co-solvency with a wide range of solvents and functional groups. In particular, Glycol Ether PnP, Glycol Ether TPM and Glycol Ether DPM are hydrophilic as well as having a low enthalpy of evaporation. The hydrophilic nature of the Glycol Ether PnP, Glycol Ether TPM and Glycol Ether DPM may provide good co-solvency with water and other solvents employed in ink compositions according to aspects of the present invention. Further, the hydrophilic property of Glycol Ether PnP, Glycol Ether TPM and Glycol Ether DPM may help retard water evaporation in the bulk ink composition. However, when the ink composition is atomized through the jets onto a non-porous substrate, the low enthalpy of evaporation property of Glycol Ether PnP, Glycol Ether TPM and Glycol Ether DPM may allow for faster evaporation and enhance faster dying of the ink on the non-porous substrate. As the term is employed herein, low enthalpy of evaporation, hydrophilic (“LEEH”) solvent refers to solvents such as Glycol Ether PnP, Glycol Ether TPM and Glycol Ether DPM.

Table I below shows the enthalpy of evaporation for various representative solvents used in exemplary embodiments of ink compositions according to aspects of the invention. As shown in Table I, water has the highest value for the enthalpy of evaporation while LEEH solvents, such as Glycol Ether TPM and Glycol Ether DPM, have the lower values for the enthalpy of evaporation. As the term is employed herein, enthalpy of evaporation is the energy required to transform a given quantity of a solvent into a gas. The lower the value for the enthalpy of evaporation of a solvent the faster the solvent may evaporate from a substrate when atomized through the jets onto a substrate.

TABLE I
Enthalpy of Evaporation (Btu/lb) for various solvents

| Solvents | Enthalpy of Evaporation (Btu/lb) |
|---|---|
| Water | 970 |
| Methanol | 473 |
| Ethylene Glycol | 369 |
| Ethanol | 364 |
| Diethylene Glycol | 234 |
| Triethylene Glycol | 179 |
| Glycol Ether DPM | 114 |
| Glycol Ether TPM | 90 |

Various mixtures of the aforementioned fast-drying solvents may be selected at an effective concentration in terms of percentage by weight for particular ink formulation according to aspects of the present invention, thereby providing balance of the desired properties, as will be appreciated by those skilled in the art.

Important properties for selecting appropriate solvents for a fast-drying thermal inkjet ink to print on a wide range of non-porous substrates include one or more of the following: substantial solubility with water; desirable evaporating rate; substantial miscibility with water; relatively low toxicity; relatively low viscosity; substantially complete dissolution of water-insoluble dyes; and substantially complete dissolution of resin.

In an exemplary embodiment of the present invention, a fast-drying solvent and/or mixtures thereof are typically present in the range of about five percent (5%) to about ninety percent (90%) by weight, more preferably in the range of about ten percent (10%) to about seventy-five percent (75%) by weight, and even more preferably in the range of about ten percent (10%) to about sixty percent (60%) by weight.

In contrast to prior art solvent inks for continuous inkjet printing, ink compositions of the present invention have water that may act as a propellant for thermal inkjet printing. Unlike prior art aqueous inks for thermal inkjet printing, ink compositions of the present invention have fast-drying solvent to enable fast drying through evaporative means with and/or without the assistance of an external heat source. Advantageously, images being printed with ink compositions comprising fast-drying solvent(s) may rapidly dry on even non-porous substrates.

As aforementioned in the prior art, inks employing fast-drying solvent and/or fast-drying solvent mixture may result in irrecoverable clogging of the nozzles and/or clogging of the nozzles requiring user intervention due to the evaporation of the fast-drying solvent and/or fast-drying solvent mixture.

### Humectants

As the term is employed herein, a humectant is a substance that may be employed to promote the retention of moisture. Polyols may generally be added to various ink compositions of the present invention for their humectant property. Humectants may play an important role in any ink formulation in preventing crusting at the nozzles. Fast drying inks of the type described in the various inventive embodiments of the present invention may be more susceptible to nozzle crusting than slower drying inks of the prior art, i.e., conventional aqueous ink compositions for thermal inkjet printing systems.

Polyols suitably employed in the ink compositions of the present invention may include, but are not limited to, ethylene glycol, diethylene glycol, triethylene glycol, tetraethylene glycol, propylene glycol, dipropylene glycol, tripropylene glycol, glycerol, polyethylene glycol 200, polyethylene glycol 400, polyethylene glycol 600, and/or derivatives thereof.

In contrast to prior art solvent inks for continuous inkjet printing, ink compositions having at least one of the aforementioned humectants in the bulk ink tend to minimize loss of solvent during low duty cycle printing or idle state. Thus, ink compositions having at least one of the aforementioned humectants do not need make-up solution to balance viscosity due to loss of VOC. Furthermore, unlike prior art aqueous inks for thermal inkjet printing, ink compositions having at least one of the aforementioned humectants may suffer less from hard-plug or nozzle-crusting due to loss of solvent during low duty cycle printing or idle state.

### Surfactants

Surfactants suitable for use in the various ink compositions of the present invention may comprise ionic, zwitterionic (amphoteric), and/or non-ionic surfactants. Surfactants are surface active agents that contain both hydrophobic groups and hydrophilic groups. Surfactants may generally be characterized by the presence of a charge on the hydrophilic group of the molecule. For example, non-ionic surfactants might have no charge on the hydrophilic portion of the molecule; whereas, ionic surfactants might have a net charge on the hydrophilic portion of the molecule. Negatively charged surfactants are called anionic surfactants, whereas, positively charged surfactants are called cationic surfactants. Furthermore, surfactants with two oppositely charged groups on the hydrophilic portion of the molecule are called zwitterionic surfactants. More generally, surfactants may be hydrocarbon-based surfactants, silicone-based surfactants, or fluorosurfactants.

Examples of suitable hydrocarbon-based surfactants may include, but are not limited to, acetylenic-based surfactants. For example, acetylenic surfactants available from Air Products™ and suitable for use in ink compositions according to the present invention include, but are not limited to, Dynol™ 604, Dynol™ 607, Surfynol® 104, Surfynol® 104A, Surfynol® 104BC, Surfynol® 104DPM, Surfynol® 104E, Surfynol® 104H, Surfynol® 104NP, Surfynol® 104PA, Surfynol® 104PG50, Surfynol® 104S, Surfynol® 2502, Surfynol® 420, Surfynol® 440, Surfynol® 465, Surfynol® 485, Surfynol® 485W, Surfynol® 502, Surfynol® 61, Surfynol® SE, Surfynol® SE-F, and Surfynol® TG-E. Other suitable non-ionic surfactants available from Air Products™ include Carbowet® 106 and Carbowet® 109.

Examples of suitable silicone-based surfactants may include, but are not limited to, CoatOSil® 1211, CoatOSil® 2400, CoatOSil® 2810, CoatOSil® 2812, CoatOSil® 2815, CoatOSil® 3500, CoatOSil® 3501, CoatOSil® 3503, CoatOSil® 3505, CoatOSil® 3509, CoatOSil® 3573, Silwet® L-77, Silwet® L-7001, Silwet® L-7200, Silwet® L-7210, Silwet® L-7220, Silwet® L-7230, Silwet® L-7280, Silwet® L-7500, Silwet® L-7510, Silwet® L-7550, Silwet® L-7600, Silwet® L-7602, Silwet® L-7604, Silwet® L-7605, Silwet® L-7607, Silwet® L-7608, Silwet® L-7650, and Silwet® L-8610. Examples of the CoatOSil® and Silwet® surfactants are available from Crompton Corp. (Union Carbide™ or OSi Specialties™).

Examples of suitable fluorosurfactants may include, but are not limited to, Zonyl® FSP, Zonyl® FSO, Zonyl® FSA, Zonyl® FSN-100, Zonyl® FSO-100, and Zonyl® FSG. Examples of the Zonyl® surfactants are available from DuPont™.

In an exemplary embodiment of the present invention, improved stability of drop formation during ink jetting is attributable, in addition to lowering the surface tension of the ink for wetting on low energy, non-porous surfaces, at least in part, to mixing a fluorosurfactant with a hydrocarbon-based surfactant or mixing a silicone-based surfactant with a hydrocarbon-based surfactant. It is contemplated that such mixtures of surfactants may reduce both the static and dynamic surface tension. It is known that high frequency jetting of ink droplets creates a dynamic situation wherein new surfaces are being created at the nozzles as the ink droplets are being ejected at a relatively small time scale, on the order of milliseconds or less. Therefore, it is postulated that an ink with dynamic surface tension similar to its static surface tension will be able to stabilise the meniscus at the nozzles faster before the next ink droplet is ejected. Furthermore, generally low surface tension ink may wet low energy surfaces better, thereby producing images free of the aforementioned print quality defects often produced by prior art TIJ aqueous inks.

The surfactant(s) or a mixture thereof may be present in an ink composition in the range of five hundredths percent (0.05%) to about three percent (3%) by weight, more preferably in the range of about seventy-five thousandths percent (0.075%) to about two percent (2%) by weight, and even more preferably in the range of about one tenth percent (0.1%) to about one-and-a-half percent (1.5%) by weight. The effective concentration of the surfactant(s) may depend on the percentage by weight of the surfactant required in the ink composition to produce the desired surface tension and wetting properties.

### Surface-Active Humectants

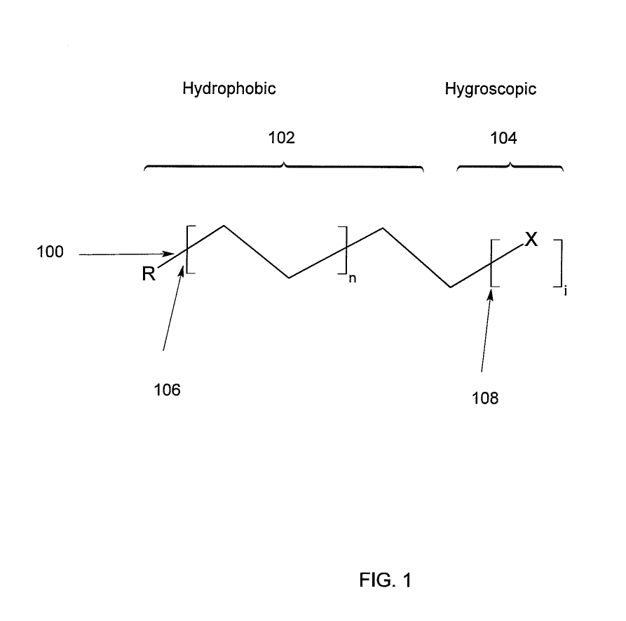

As the term is employed herein, surface-active humectants (“SAH”) are molecules that contain both hygroscopic groups and hydrophilic groups. FIG. 1 shows a simplified, idealized chemical structure of a surface-active humectant. A generalized surface-active humectant chemical structure 100 may comprise of a hydrophobic end 102 and a hygroscopic end 104.

With continued reference to FIG. 1, the hydrophobic end 102 may comprise a repeating unit “n” 106, where “n” may have a value from 1 to 36. The hydrophobic end may be linear and/or branch in physiochemical structure. The repeating unit 106 may be alkane-based (CH₂)n, fluoro-based (CF₂)n, and/or silicone-based (SiO)n. In general, fluoro- and/or silicone-based hydrophobic ends tend to be more hydrophobic than alkane-base hydrophobic ends. Further, the shorter the repeating unit “n” the more miscible the SAH molecule is in water. Additionally, the shorter the chain length the more mobile the SAH molecule. Thus, the hydrophobic end 102 may be tailored to have specific mobility, miscibility, and/or hydrophobicity by engineering the appropriate hydrophobic end 102 with predetermined physiochemical structure.

The hygroscopic end 104 may be comprised of a plurality “i-repeating units” of functional groups “X” 108, where “i” may have a value from 2 to 8. The functional groups “X” 108 may be, but are not limited to, a hydroxyl group, an amine group, a carboxyl group and/or an ester group. The property of the hygroscopic group is the affinity of the functional group to form hydrogen bonds with water molecules. Thus, the hygroscopic end 104 may be tailored to give the SAH molecule the ability to attract and retain water molecules from the surrounding environment.

The hygroscopic end 104 may be comprised of a plurality “i” of functional groups “X”. The functional groups “X” may be vicinally attached, i.e., vicinal refers to functional groups bonded to two adjacent atoms. Alternatively, the functional groups may be geminally attached, i.e., geminal refers to functional groups bonded to the same atom. Thus, the affinity to attract water from the surrounding environment is accentuated with SAH molecules comprising of a plurality of functional groups, where the functional groups are attached in a vicinal and/or geminal manner.

Examples of suitable surface-active humectants may include, but are not limited to, 1,2-propane diol, 1,2-butanediol, 1,2-pentanediol, isopropyl glycerol ether, 1,2-hexane diol, 1,2-heptane diol, 1,2-octane diol, 1,2-decane diol, 1,2-undecane diol, 1,2-dodecane diol, 2,3-dihydroxy propyl octadecanoate, and/or derivatives thereof.

It should be noted that surface-active humectant molecules may be employed in an ink composition as smart molecules to spontaneously provide at least a hygroscopic layer through self-assembly at a predetermined location, i.e., below the air-water interface, to attract and/or retain water molecules while retarding the evaporation of water molecules to prevent and/or minimize irrecoverable clogging at the nozzles. Thus, the self-assembly of the SAH molecules is a result of spontaneous and reversible organization of the SAH molecules into ordered structures by non-covalent interactions of the hydrophobic end groups.

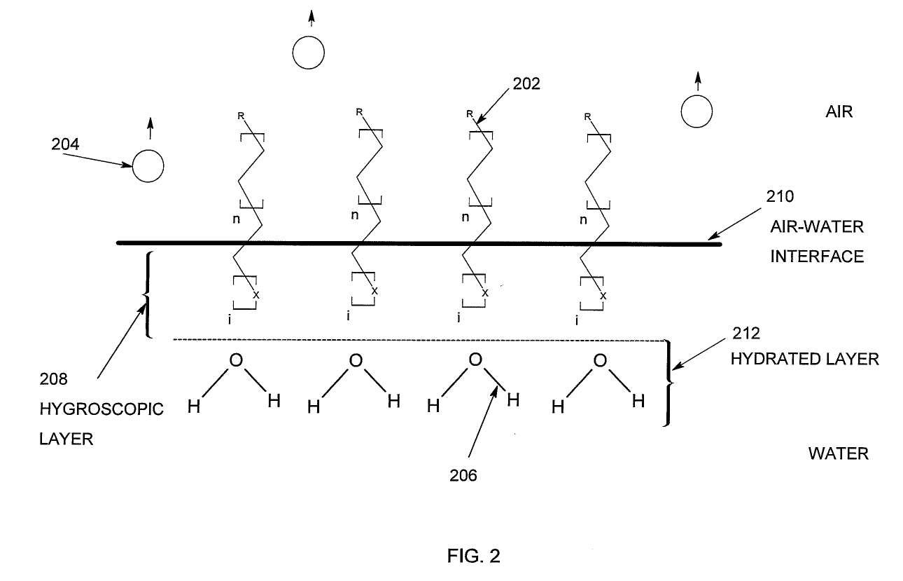

In accordance with another embodiment of the invention, FIG. 2 shows a simplified schematic of the surface-active humectants at an air-water interface. An ink composition comprising at least surface-active humectant molecules 202, fast-drying solvent molecules 204, water molecules 206, and/or other additives (not shown to simplify drawing) to form a jettable ink formulation. The SAH molecules 202, after forming a critical micelle concentration (“CMC”) in the bulk ink (not shown), may migrate to a surface, e.g., a meniscus at a nozzle.

With continued reference to FIG. 2, the SAH molecules 202 may form a hygroscopic layer 208 at the surface, i.e., air-water interface 210. As aforementioned, SAH molecule 202 may be comprised of a hydrophobic end 102 and a hygroscopic end 104 (FIG. 1). The hydrophobic end of the SAH molecules 202 may provide the SAH molecules 202 with the thermodynamic driving force to spontaneously migrate toward the surface once the CMC is reached in the bulk ink. The thermodynamic driving force for the spontaneous, self-assembly of the SAH molecules at the air-water interface is a result of the system lowering the Gibbs free energy to achieve thermodynamic stability.

The SAH molecules 202 may be oriented with the hydrophobic ends toward the air and the hygroscopic ends toward the water to form a hygroscopic layer 208 at the air-water interface 210. As fast-drying solvent molecules 204 evaporate from the bulk ink, the hygroscopic layer 208 may serve to provide a barrier to attract and retain water molecules in the bulk ink. Thus, hygroscopic groups from SAH molecules 202 form a hygroscopic layer 208, wherein the hygroscopic groups form hydrogen bonding with water molecules 206 to keep a hydrated layer 212 below the air-water interface 210 preventing the nozzles from irrecoverable clogging.

Although not wishing to be bound by theory, the inventors herein believe SAH molecules may be employed as smart molecules in an ink composition to spontaneously form a hygroscopic layer below the air-water interface, such as at the meniscus of a nozzle, to prevent and/or minimize clogging of the nozzle due to evaporation.

An effective concentration of SAH may be empirically determined relative to the desired end use application to balance between the problem of crusting at the nozzles and achieving other properties of the ink, e.g., viscosity and/or dry time.

In an exemplary embodiment of the present invention, SAH and/or a mixture of SAH may typically be present in the range of about a hundredth of a percent (0.01%) to about ten percent (10%) by weight, more preferably in the range of about a tenth of a percent (0.1%) to about five percent (5.0%) by weight, and even more preferably in the range of about half a percent (0.5%) to about four percent (4.0%) by weight.

### Colorants

The ink compositions of the present invention generally comprise a colorant which might be a dye, a pigment or combination thereof. Any colorant that may be dissolved and/or dispersed in the ink composition to achieve the targeted color and optical density may be used in the present invention.

The selected colorants suitable for the various ink compositions of the present invention may be cationic dyes, anionic dyes, solvent dyes, and/or pigments. For example, cationic dyes (basic Dyes) are soluble in water and good dilutability in alcohols and/or glycol ethers. Whereas, anionic dyes (acid dyes and direct dyes) are predominantly water soluble and may be moderate dilutable in alcohols and glycol ethers. In some cases, the solvent dyes may be soluble in alcohol and/or glycol ethers. Further, pigments may also be dispersed in water, alcohols and/or glycol ethers.

Examples of suitable colorants may include, but are not limited to, Basonyl Blue 640 (Basic Blue 26), Basic Blue 636 (Basic Blue 7), Basonyl Violet 610 (Basic Violet 3), Basonyl Red 540 (Basic Violet 10), Basonyl Red 483 (Basic Red 1), Basonyl Red 481 (Basic Red 1:1), Basonyl Yellow 110 (Basic Yellow 2), Basonyl Yellow 105 (Basic Yellow 37), Basic Blue 47, Basic Blue 66, Basic Red 9 (Fuchsin), Basic Violet 14, Astrazone Orange G (Basic Orange 21), Auramine 0 (Basic Yellow 2), Basic Green 1, Basic Green 4, Chrysoidin (Basic Orange 2), Acid Black 2, Acid Black 24, Acid Black 52, Acid Black 210, Direct Black 22, Acid Blue 7, Acid Blue 9, Acid Blue 45, Acid Blue 93, Acid Blue 110, Direct Blue 86, Direct Blue 199, Reactive Blue 2, Reactive Blue 4, Acid Green 1, Acid Orange 10, Direct Orange 31, Acid Orange 7, Acid Red 1, Acid Red 14, Acid Red 52, Acid Red 87, Acid Red 92, Acid Red 94, Reactive Red 23, Reactive Red 180, Reactive Red 24, Acid Red 27, Direct Red 75, Reactive Red 4, Acid Violet 9, Acid Yellow 3, Acid Yellow 5, Acid Yellow 36, Acid Yellow 73, Acid Yellow 11, Acid Yellow 23, Acid Yellow 40, Direct Yellow 132, Reactive Yellow 2, Direct Yellow 9, Acid Black 2, Acid Black 24, Acid Black 52, Acid Black 210, Direct Black 22, Acid Blue 7, Acid Blue 9, Acid Blue 45, Acid Blue 93, Acid Blue 110, Direct Blue 86, Direct Blue 199, Reactive Blue 2, Reactive Blue 4, Acid Green 1, Acid Orange 10, Direct Orange 31, Acid Orange 7, Acid Red 1, Acid Red 14, Acid Red 52, Acid Red 87, Acid Red 92, Acid Red 94, Reactive Red 23, Reactive Red 180, Reactive Red 24, Acid Red 27, Direct Red 75, Reactive Red 4, Acid Violet 9, Acid Yellow 3, Acid Yellow 5, Acid Yellow 36, Acid Yellow 73, Acid Yellow 11, Acid Yellow 23, Acid Yellow 40, Direct Yellow 132, Reactive Yellow 2, Direct Yellow 9, Solvent Black 3, Solvent Black 5, Solvent Black 29, Solvent Blue 38, Solvent Red 24, Solvent Red 73, Solvent Red 8, Solvent Red 122, Solvent Violet 49, Solvent Yellow 79, Solvent Yellow 62, Solvent Yellow 83, Solvent Orange 41, Solvent Orange 62, Pigment Black 7, Pigment Blue 15:3, Pigment Blue 15:4, Pigment Red 122, Pigment Red 168, Pigment Red 170, Pigment Red 176, Pigment Red 185, Pigment Yellow 83, Pigment Yellow 120, Pigment Yellow 139, Pigment Yellow 151, Pigment Yellow 155, Pigment Yellow 180, and/or Pigment Violet 19.

Basic dyes may be available from BASF™ under the trade name of Basonyl® Dyes. Other colorants may be available from Lanxess™, Clariant™, Keystone™ Aniline Co., Sensient™, Degussa™, Cabot™, and/or Orient™ Corp.

The colorant might be present in an ink composition according to the present invention in the range of about a half percent (0.5%) to about twelve percent (12%) by weight, more preferably in the range of about one percent (1%) to about seven percent (7%) by weight, and even more preferably in the range of about two percent (2%) to about five percent (5%) by weight. The effective concentration of the colorant may depend on the percentage by weight of the colorant required in the ink composition to produce the desired color and optical density.

### Resins

In an exemplary embodiment, resins may be employed to improve adhesion of the ink to the substrate. Examples of suitable water-soluble and water-dispersible resins that may be included in various ink compositions of the present invention include, but are not limited to, acrylic, polyvinyl alcohols, polyvinyl pyrollidone, polyester emulsion, styrene maleic anhydride, cellulose acetate resins, and derivatives thereof. Analogously, suitable solvent-soluble resins with tolerance for water may include, but are not limited to, acrylic, cellulose acetate, polyketone, polyvinyl alcohol, phenolic, novolac resins, and derivatives thereof.

Examples of the aforementioned resins or polymers may be available as Joncryl® manufactured by S. C. Johnson, PVP manufactured by Air Products™, MOWIOL® manufactured by Kurary™, and Synthetic Resin DS manufactured by Degussa™.

### Additives

Biocide reagents for use in various ink compositions according to aspects of the present invention may include, but are not limited to, 2-bromo-2-nitropropane-1,3-diol, 4,4-dimethyloxazolidine, 7-ethyl bicyclooxazolidine, 2,6-dimethyl-m-dioxan-4 of acetate, 1,2-benzisothiazolin-3-one, sodium o-phenylphenate, 1- (3-chloroallyl)-3,5,7-triaza-1-azoniaadamantane chloride, glutaraldehyde, sodium hydroxymethylglycinate, 2[(hydroxymethyl)amino]ethanol, 5-hydroxymethyl-1-aza-3,7-dioxabicyclo(3.3.0)octane, n-methyl-2-hydroxymethyleneoxypropyl-2′-hydroxypropylamine, alkyl amine hydrochlorides, tetrahydro-3,5-dimethyl-2h-1,3,5-thiadiazine-2-thione, tributyltin benzoate, and derivatives thereof.

Examples of the aforementioned biocide reagents may be available as Nuosept® manufactured by Huls America (International Specialty Products™), Proxel® GXL manufactured by Arch UK Biocides (Avecia™), Bioban® and Canguard® manufactured by Angus Chemical Co., Dowicide® and Dowicil® manufactured by Dow Chemical Co., and Ucarcide® manufactured by Union Carbide Corp.

Amines may generally be employed to increase the pH of an ink composition to help with dissolving various dyes such as “direct dyes” or various resins such as acrylics. Amines suitable for the ink compositions of the present invention may include, but are not limited to, ethylenediamine, diethylenetriamine, triethylenetetriamine, diethanolamine, triethanolamine, AMP-95 and derivatives thereof.

Keto-pyrroles may be five-membered lactams such as n-methylpyrrolidone 2-pyrrolidone and derivatives thereof. Keto-pyrroles may be employed to help increase the solubility of an ink composition due to their inherent relatively good solvency.

Various mixtures of the aforementioned fast-drying solvents, co-solvents and/or additives may be selected at an effective concentration in terms of percentage by weight for particular ink formulation according to aspects of the present invention, thereby providing balance of the desired properties, as will be appreciated by those skilled in the art. Important properties for selecting appropriate solvents for a fast-drying thermal inkjet ink to print on a wide range of non-porous substrates include one or more of the following: substantial solubility with water; desirable evaporating rate; substantial miscibility with water; relatively low toxicity; relatively low viscosity; substantially complete dissolution of water-insoluble dyes; and substantially complete dissolution of resin. In an exemplary embodiment of the present invention, organic solvents or mixtures thereof are typically present in the range of about five percent (5%) to about ninety percent (90%) by weight, more preferably in the range of about ten percent (10%) to about seventy-five percent (75%) by weight, and even more preferably in the range of about ten percent (10%) to about sixty percent (60%) by weight.

### Exemplary Formulations

The following non-limiting examples illustrate ink compositions according to aspects of the present invention suitable for jetting in an industrial thermal inkjet system such as the JETPACK 1000™ available from Prism, Inc. The exemplary formulations should not be construed in any way as limitations on the present invention, but should be understood merely as illustrative of the principles of the invention and instructive of at least one preferred ink composition based on current materials and data. The following ink formulations, shown in Table II below, may be made using conventional ink mixing equipment.

TABLE II
Representative Ink Formulations

| Ink Formula (% by weight) | 02-0064.20 | 02-0070.02 |
|---|---|---|
| DI Water | 56.6 | 54.6 |
| GE DPM | 3 | 3 |
| GE PM | 8 | 8 |
| Diacetone Alcohol | 3 | 3 |
| 1,2 hexanediol | | 2 |
| Methanol | 2 | 2 |
| Ethanol | 8 | 8 |
| Dynol 604 | 0.1 | 0.1 |
| Zonyl FSO-100 (20% alcohol) | 0.1 | 0.1 |
| TEA | 0.2 | 0.2 |
| Sensijet Black SDP 100 (15%) | 15 | 15 |
| Sensijet DMX Black | 4 | 4 |
| TOTAL | 100 | 100 |
| Viscosity @ 25 Degrees C. (cPs) | 2.5 | 2.5 |
| Surface Tension @ 25 Degree C. (mN/m) | 23.1 | 23.2 |
| pH | 8.05 | 7.9 |

The viscosities of the inks were measured on a Brookfield™ viscometer Model DV-E with spindle UL Cup at 60 rpm and 25° C. The viscometer may be available from Brookfield Engineering Co. The measured unit of viscosity is centipoises (cPs).

The surface tension (ST) of each of the exemplary inks was measured on a surface tensiometer Model 703 with a DuNoy Ring at 25° C. The tensiometer may be available from KSV Instruments in Finland. The measured unit of surface tension is milli-Newtons per meter (mN/m).

The pH of each of the exemplary inks was measured on a pH meter model HI 1295 at 25° C. The pH meter may be available from Hanna Instruments.

The Zonyl FSO-100 employed in the formula 02-0064.20 and formula 02-0070.02 is a solution of 20% Zonyl in Ethanol. Similarly, the Sensijet Black SDP 100 is a 15% concentrated pigment dispersion provided in a proprietary dispersion from the supplier, such that the actual concentration of Sensijet Black SDP 100 in the two exemplary formulations is 2.25%.

In view of the foregoing, a method of ink-jet printing is also disclosed herein based on aspects of the various ink compositions of the present invention. Such inks may be jetted in continuous ink-jet, conventional ink-jet, bubble-jet, or piezoelectric printers, whether for industrial or office use. As a non-limiting example, the ink may be jetted through a thermal ink-jet system such as the JETPACK 1000™ available from Prism, Inc. As may be appreciated, the aforementioned method serves not as a limitation on the present invention, but is merely illustrative of how an ink composition according to aspects of the present invention may be employed to print on a variety of substrates.

Examples of non-porous substrates to which inks according to aspects of the present invention may be applied include, but are not limited to, polypropylene, polyethylene terephthalate (“PET”), polyethylene, coated glossy paper, and the like. Any such ink jetted from the JETPACK 1000™ available from Prism, Inc. produces images with good image quality and contrast.

Table II above shows, in accordance with an embodiment of the invention, two representative fast-drying ink formulations, formula 02-0064.20 and formula 02-0070.02. Formula 02-0064.20 is the fast-drying ink composition without the SAH molecules, and formula 02-0070.02 is the fast-drying ink composition with the SAH molecules, i.e., 1,2-hexanediol.

Formula 02-0064.20 when left uncapped on the JETPACK 1000™ has poor recovery. For example, the ink cartridge with formula 02-0064.20 may require user intervention such as wiping and/or vacuuming ink through the orifices to clear the clogging at the nozzles.

In contrast, Formula 02-0070.02 when left uncapped on the JETPACK 1000™ has very good recovery. The printed image of the ink cartridge with formula 02-0070.02 is almost the same, with the exception of a few missing jets at the leading edge, as the baseline print before the uncapping. The subsequent print results in a full recovery of all jets without requiring user intervention to wipe the nozzle face plate or vacuum the orifices. Thus, a software algorithm may be employed to sacrificially fire the jets to unclog the nozzles prior to printing to ensure full recovery of all jets after standing idle uncapped.

It will be appreciated by those skilled in the art that while a number of specific examples of ink ingredients and compositions have been provided, the present invention is not so limited. Rather, again, while broad categories of ingredients have been provided generally, such as primary and secondary solvents, colorants, surfactants, resins, biocide reagents, and the like, and specific substances within each broad category of ingredients have been described as being combined in certain proportions to yield one or more particular ink compositions, those skilled in the art will appreciate that numerous other substances, now known or later developed, and combinations thereof are possible beyond those described herein without departing from the spirit and scope of the invention.

Generally, the various ink compositions according to aspects of the present invention are known to have at least one of the following advantages: good recovery from uncapped standby; stability for jetting from a thermal print head; fast drying without the need for a make-up solution; high optical density; good wetting for printing on non-porous substrates; and economical operation within a relatively inexpensive printing system with low initial cost and low cost of ownership.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A fast-drying ink composition comprising:
water;
a fast-drying solvent mixture including a hydrophilic co-solvent having low enthalpy of evaporation;
a surface-active humectant; and
a colorant.

2. The ink composition of claim 1 wherein the hydrophilic co-solvent is selected from the group consisting of propylene glycol n-propyl ether, tripropylene glycol methyl ether, and dipropylene glycol methyl ether.

3. The ink composition of claim 1 wherein the hydrophilic co-solvent has an enthalpy of evaporation of less than 175 Btu/lb.

4. The ink composition of claim 1 wherein the solvent mixture is present within the ink composition in the range of about five percent (5%) to about ninety percent (90%) by weight, more preferably in the range of about ten percent (10%) to about seventy-five percent (75%) by weight, and most preferably in the range of about ten percent (10%) to about sixty percent (60%) by weight.

5. The ink composition of claim 1 wherein the surface-active humectant comprises:
a hydrophobic end having a repeating unit “n” ranging from 1 to 36 and selected from the group consisting of alkane-based (CH₂)n, fluoro-based (CF₂)n, and silicone-based (SiO)n; and
a hygroscopic end having a repeating unit “i” ranging from 2 to 8 and selected from the group consisting of a hydroxyl group, an amine group, a carboxyl group and an ester group.

6. The ink composition of claim 5 defining an air-water interface between air thereabout and the water contained within the ink composition, wherein the surface-active humectant is oriented with each hydrophobic end toward the air and each hygroscopic end toward the water to form a hygroscopic layer at the air-water interface, whereby as the fast-drying solvent mixture evaporates from the ink composition, the hygroscopic layer serves to provide a barrier to attract and retain water molecules in the ink composition, such that the hygroscopic layer forms hydrogen bonds with the water to keep a hydrated layer below the air-water interface, thus preventing irrecoverable nozzle clogging.

7. The ink composition of claim 1 wherein the surface-active humectant is selected from the group consisting of 11,2-propane diol, 1,2-butanediol, 1,2-pentanediol, isopropyl glycerol ether, 1,2-hexane diol, 1,2-heptane diol, 1,2-octane diol, 1,2-decane diol, 1,2-undecane diol, 1,2-dodecane diol, and 2,3-dihydroxy propyl octadecanoate.

8. The ink composition of claim 1 wherein the surface-active humectant is present within the ink composition in the range of about a hundredth of a percent (0.01%) to about ten percent (10%) by weight, more preferably in the range of about a tenth of a percent (0.1%) to about five percent (5.0%) by weight, and most preferably in the range of about half of a percent (0.5%) to about four percent (4.0%) by weight.

9. The ink composition of claim 1 wherein the colorant is present in the ink composition in the range of about a half of a percent (0.5%) to about twelve percent (12%) by weight, more preferably in the range of about one percent (1%) to about seven percent (7%) by weight, and most preferably in the range of about two percent (2%) to about five percent (5%) by weight.

10. The ink composition of claim 1 further comprising at least one surfactant selected from the group consisting of hydrocarbon-based surfactants, silicone-based surfactants, and fluoro surfactants.

11. The ink composition of claim 10 comprising at least two surfactants defined as a fluoro surfactant and a hydrocarbon-based surfactant.

12. The ink composition of claim 10 comprising at least two surfactants defined as a silicone-based surfactant and a hydrocarbon-based surfactant.

13. The ink composition of claim 10 wherein the surfactant is present within the ink composition in the range of five hundredths of a percent (0.05%) to about three percent (3%) by weight, more preferably in the range of about seventy-five thousandths of a percent (0.075%) to about two percent (2%) by weight, and most preferably in the range of about one tenth of a percent (0.1%) to about one-and-a-half percent (1.5%) by weight.

14. The ink composition of claim 1 further comprising a resin selected from the group consisting of acrylic, polyvinyl alcohol, polyvinyl pyrollidone, polyester emulsion, styrene maleic anhydride, cellulose acetate, polyketone, phenolic, and novolac.

15. The ink composition of claim 1 further comprising a biocide reagent selected from the group consisting of 2-bromo-2-nitropropane-1,3-diol, 4,4-dimethyloxazolidine, 7-ethyl bicyclooxazolidine, 2,6-dimethyl-m-dioxan-4 of acetate, 1,2-benzisothiazolin-3-one, sodium o-phenylphenate, 1-(3-chloroallyl)-3,5,7-triaza-1-azoniaadamantane chloride, glutaraldehyde, sodium hydroxymethylglycinate, 2](hydroxymethyl)amino]ethanol, 5-hydroxymethyl-1-aza-3,7-dioxabicyclo(3.3. 0)octane, n-methyl-2-hydroxymethyleneoxypropyl-2′-hydroxypropylamine, alkyl amine hydrochlorides, tetrahydro-3,5-dimethyl-2h-1,3,5-thiadiazine-2-thione, and tributyltin benzoate.

16. A fast-drying ink composition comprising:
water;
a fast-drying solvent mixture including a hydrophilic co-solvent selected from the group consisting of propylene glycol n-propyl ether, tripropylene glycol methyl ether, and dipropylene glycol methyl ether;
a colorant; and
a surface-active humectant comprising:
a hydrophobic end having a repeating unit “n” ranging from 1 to 36 and selected from the group consisting of alkane-based (CH₂)n, fluoro-based (CF₂)n, and silicone-based (SiO)n; and
a hygroscopic end having a repeating unit “i” ranging from 2 to 8 and selected from the group consisting of a hydroxyl group, an amine group, a carboxyl group and an ester group;
wherein the ink composition defines an air-water interface between the air thereabout and the water contained within the ink composition, the surface-active humectant being oriented with each hydrophobic end toward the air and each hygroscopic end toward the water to form a hygroscopic layer at the air-water interface, whereby as the fast-drying solvent mixture evaporates from the ink composition, the hygroscopic layer serves to provide a barrier to attract and retain water molecules in the ink composition, such that the hygroscopic layer forms hydrogen bonds with the water to keep a hydrated layer below the air-water interface, thus preventing irrecoverable nozzle clogging.

17. The ink composition of claim 16 wherein the hydrophilic co-solvent has an enthalpy of evaporation of less than 175 Btu/lb.

18. A fast-drying ink composition comprising:
about ten percent (10%) to about sixty percent (60%) by weight fast-drying solvent mixture including a hydrophilic co-solvent;
about half of a percent (0.5%) to about four percent (4.0%) by weight surface-active humectant; and
about two percent (2%) to about five percent (5%) by weight colorant.

19. The ink composition of claim 18 further comprising:
at least one surfactant selected from the group consisting of hydrocarbon-based surfactants, silicone-based surfactants, and fluorosurfactants, wherein the at least one surfactant is present within the ink composition in the range of about one tenth of a percent (0.1%) to about one-and-a-half percent (1.5%) by weight; and
the balance water.

20. The ink composition of claim 18 wherein the hydrophilic co-solvent is selected from the group consisting of propylene glycol n-propyl ether, tripropylene glycol methyl ether, and dipropylene glycol methyl ether and has an enthalpy of evaporation of less than 175 Btu/lb.
